(19) United States
(12) Patent Application Publication
(10) Pub. No.: US 2019/0009620 A1
(43) Pub. Date: Jan. 10, 2019

(54) FRICTION DAMPED TIRE BEAD CORE HAVING WRAPPED WIRES

(71) Applicant: Ford Global Technologies, LLC, Dearborn, MI (US)

(72) Inventors: David Scott Rohweder, Troy, MI (US); Arne Jontza, Monchengladbach (DE); Arne Heyden, Cologne (DE)

(21) Appl. No.: 15/642,468

(22) Filed: Jul. 6, 2017

(51) Int. Cl. B60C 15/04

(52) U.S. Cl. CPC B60C 15/04; B60C 2015/046

(57) ABSTRACT

A method and system is disclosed for increasing damping capacity in a pneumatic tire by utilizing an extruded vibration-damping rope comprising a bundle of individual wires encased by a polymerized outer sheath. The rope is embedded into the tire during the molding process. The individual wires allow inter-wire friction to occur during part vibration. The core of the disclosed inventive concept for embedding in the tire comprises a bundle of wires having an outermost layer and a polymerized sheath formed over the bundle of wires. The sheath has an inner layer. At least some of the wires of the outermost layer of wires are embedded in the inner layer, whereby sliding movement of the surfaces of the wires relative to one another dampens resonant tire vibration. The wires are metal and the sheath is composed of a polymerized material that is preferably impermeable to the in-flow of rubber.

### TECHNICAL FIELD

The disclosed inventive concept relates to vehicle tires that demonstrate reduced structure borne and airborne noise. More particularly, the disclosed inventive concept relates to vehicle tires having a bead core formed from wires encased in an impermeable rubber or rubber-like sheath that separates the wires from the molded rubber of the tire. The rubber sheath is preferably impermeable to the in-flow of rubber material from the tire during the molding process. The bundle of wires and the impermeable sheath defines a vibration-damping rope in which the outermost layer of wires of the bundle of wires is bonded to the inner surface of the impermeable sheath by being partially embedded therein. A coulomb friction thus results between the unbonded internal wires of the sheathed wire bundle.

### BACKGROUND OF THE INVENTION

Pneumatic tires have been utilized on motorized vehicles since the very earliest days of motoring. Early wheel rims were of the clincher variety in which a pair of opposed turned-in rim edges provided a seat for the tire beads which were snapped into place. Later wheel rims adopted outwardly-flared bead seats. This later style rim is the type normally fitted to the modern automotive vehicle.

Even the earliest types of tires included a pair of opposed beads with each bead forming a ring at each opening of the tire. Such beads have conventionally included bead cores formed from windings of at least one bead wire, typically a steel monofilament. The beads are virtually inelastic compared with the rest of the tire and prevent the tire from unintentionally being loosened from the wheel rim.

Today's tire relies on a bead construction that has changed little since its initial design. Functioning adequately for its purpose, tire designers had little incentive to improve over the conventional bead design. However, automobile manufacturers are increasingly reviewing all features of the vehicle in terms of reducing noise, vibration and harshness (NVH) during operation. The vehicle tire is one such feature being reexamined as a possible area for NVH reduction.

Many vehicle components are subjected to vibration which is a significant component of undesired NVH. Mechanical and structural components such as vehicle suspensions, engine blocks, and turbine blades and discs as well as support structures for motors, pumps, centrifugal machines and the like are commonly subjected to vibration. When this occurs, these components experience a periodic motion in alternately opposing directions from the position of equilibrium which induces loads that can lead to reduced component life.

Structure borne noise and airborne noise are mainly the byproduct of tires produced according to conventional techniques. Current optimization methods for reducing structure borne noise in tires rely on influencing the first radial mode and depend mainly on either adding damping mass or reducing vertical stiffness. The disadvantages of these methods are that they significantly reduce rolling resistance of the tire or reduce the handling (steering) performance of the vehicle, possibly both. Structure borne noise in a vehicle refers to any noise noticed within a vehicle. The structure borne noises in the vehicle are generally divided into three categories. Structure borne noise having a frequency range of between 60-300 Hz is referred to as “low rumble” noise, noise having a frequency range of between 125-200 Hz is referred to as “high rumble” noise, while noise having a frequency range of between 200-300 Hz is referred to as “cavity” noise. Conversely, airborne noise is defined as any noise noticed within a vehicle having a frequency range of 630-3150 Hz.

Both vehicle and tire manufacturers are devoting an increasing amount of attention to structure borne noise normally generated by the vehicle tire as one of the major quality and competitive areas of reducing vehicle NVH. In the instance of plastics, elastomers, or other polymerized materials such as vehicle tires, these materials inherently have a relatively high damping capacity where the vibrational energy associated with their periodic motion is gradually converted to heat or sound as a result of the internal material damping. However, vehicle tires, while have a generally high damping capacity, are still sources of considerable undesirable NVH, particularly in the instance of airborne noise. Tire manufacturers have found that airborne noise could be mainly minimized by changing the tread pattern design. Another option is to close the lateral grooves in the tire shoulders area to block the sound. However, this measure has a negative effect on vehicle handling on wet roadway surfaces.

In view of the state of the art, it may be advantageous to provide a tire construction offering reduced NVH by including a construction that aids in damping. As in so many areas of tire manufacturing technology, there is always room for improvement related to friction damping relative to interacting mechanical and structural components.

### SUMMARY OF THE INVENTION

The disclosed inventive concept provides a method and system for increasing damping capacity in a pneumatic tire by utilizing a vibration-damping rope comprising a bundle of individual wires encased by a polymerized outer sheath. The vibration-damping rope is embedded in the tire during the tire molding process. The individual wires allow inter-wire friction to occur during part vibration. The disclosed inventive concept thus runs contrary to the accepted technique of directly connecting wires in the bead core by the tire rubber. Instead, only the outer wires of the bundle of wires are bonded to an encasing rubber sheath, thereby allowing coulomb friction to be generated between the un-bonded wires of the wire bundle. This friction provides a significant increase in the damping capacity of the tire bead core, which reduces the noise emission of the tire.

The tire bead core of the disclosed inventive concept for embedding in a pneumatic tire comprises a bundle of wires having an outermost layer and a polymerized sheath formed over the bundle of wires. The sheath has an inner layer. At least some of the wires of the outermost layer of wires are embedded in the inner layer and are thus bonded thereto, whereby sliding movement of the surfaces of the un-bonded wires relative to one another dampens resonant tire vibration.

The wires are composed of a metal. The wires may be composed of the same metal or may be composed of different metals. The wires may be arranged linearly or helically. The sheath is composed of a polymerized material that is preferably a layer that is impermeable to the in-flow of rubber during the tire molding process.

The vibration-damping rope is preferably formed by extrusion in which at least a portion of the bundle of wires is placed into an extruder. A polymerizable material is added to the extruder to form an outer layer over the wire bundle. By controlling certain parameters surrounding the extrusion process such as temperature of the polymerizable material and extrusion speed, at least a portion of the outermost array of wires is embedded in the inner layer of the outer sheath.

The damping frequencies may be adjusted with different friction combinations by changing the material individual for every wire or for the total for all wires. Additionally the wire shape, thickness, structure and any pretention are factors that can be manipulated to adjust the friction and thus adjust the damping frequencies. The disclosed inventive concept provides a new way of improving the noise behavior of a pneumatic tire with potentially no deterioration in handling, rolling resistance and wet road surface performance. The disclosed inventive concept also allows for the adjustment of damped frequencies.

The above advantages and other advantages and features will be readily apparent from the following detailed description of the preferred embodiments when taken in connection with the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention wherein:

FIG. 1 is a cross-sectional view of a portion of a tire illustrating the tire bead construction according to known technology;

FIG. 2 is an enlarged cross-sectional view of the bead portion of the tire illustrated in FIG. 1 according to known technology;

FIG. 3 is a detailed cross-sectional view of the bead portion of a tire according to the disclosed inventive concept wherein the wires are encased in an impermeable sheath;

FIG. 4 is a detailed cross-sectional view of the bead portion of a tire shown in isolation according to the disclosed inventive concept wherein the outer wires of the internal wire bundle are illustrated as being bonded to the outer impermeable sheath and the inner wires are of the same diameter; and

FIG. 5 is a detailed cross-sectional view of the bead portion of a tire shown in isolation according to the disclosed inventive concept wherein the outer wires of the internal wire bundle are illustrated as being bonded to the outer impermeable sheath and the inner wires are of different diameters.

### DETAILED DESCRIPTION OF THE PREFERRED EMBODIMENT

In the following figures, the same reference numerals will be used to refer to the same components. In the following description, various operating parameters and components are described for different constructed embodiments. These specific parameters and components are included as examples and are not meant to be limiting.

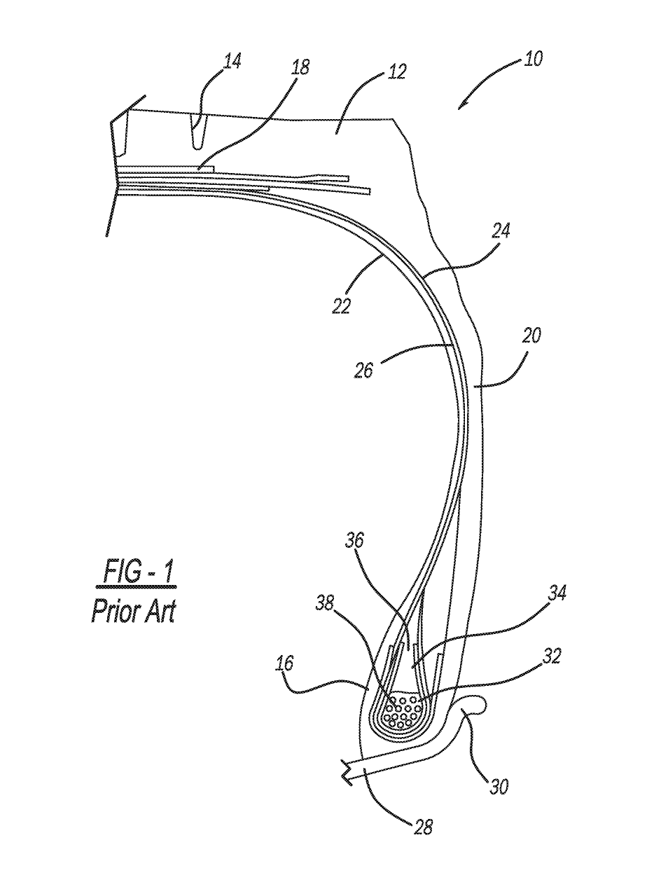

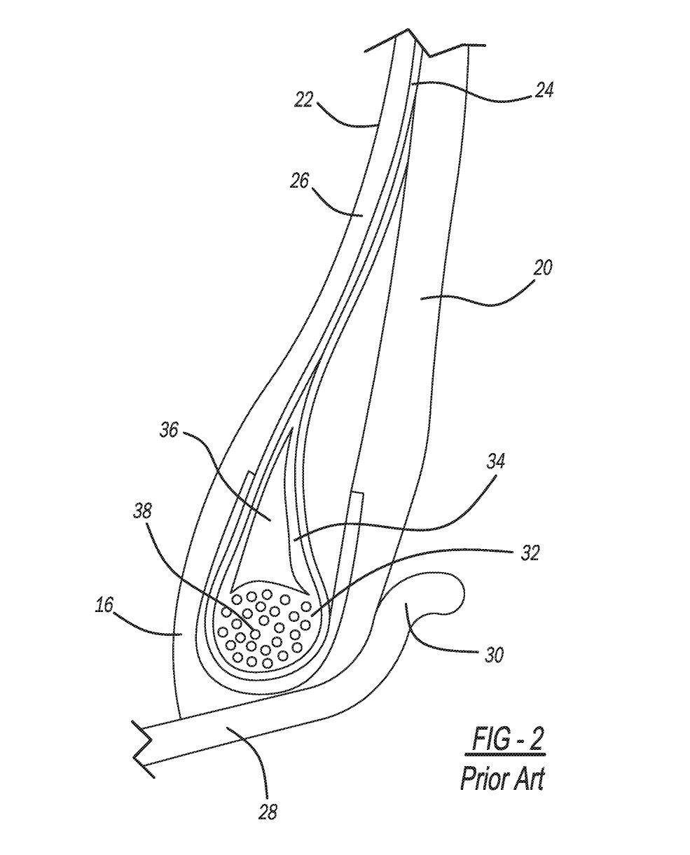

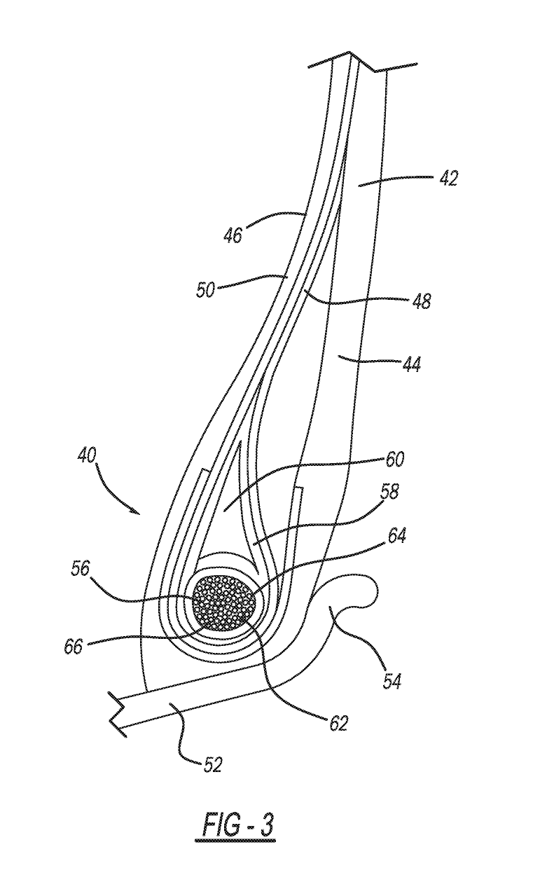

The accompanying figures and the associated description illustrate the construction and use of vibration-damping wires encased in a sheath which is embedded in the bead of a pneumatic tire. The prior art pneumatic tire is illustrated in FIGS. 1 and 2. Embodiments of the disclosed inventive concept are illustrated in FIGS. 3, 4 and 5. It is to be understood that the illustrated embodiment of the disclosed inventive concept is suggestive and is not intended as being limiting provided that the general objective of the disclosed inventive concept is to provide a vibration-damping rope comprising a bundle of wires encased in a sheath that is impermeable to the in-flow of rubber material. The outermost layer of wires of the bundle of wires is bonded to the inner surface of the impermeable sheath. A coulomb friction thus results between the unbonded internal wires of the sheathed wire bundle.

Referring to FIG. 1, a cross-sectional view of a known pneumatic tire, generally illustrated as 10, is shown. The pneumatic tire 10 includes a peripheral crown 12 having a tread 14 formed therein. A tire bead 16 is formed to ring each opening of the pneumatic tire 10. A belts 18 is embedded beneath the peripheral crown 12 to provide the pneumatic tire 10 with resilience and strength. The belt 18 comprises individual cords, typically steel cords, although cords made from other materials may be used.

Between the peripheral crown 12 and the tire bead 16 is formed a sidewall 20. An inner liner 22 is formed on the entire surface of the inside of the pneumatic tire 10. An internal breaker 24 is continuously formed between the peripheral crown 12 and the bead 14. Between the internal breaker 24 and the inner liner 22 is formed a tire carcass 26. The tire carcass 26 comprises one or more plies of cords as is known in the art. The individual cords are composed of steel or another resilient material, such as a polymerized material.

The pneumatic tire 10 is mounted on a wheel rim 28. As illustrated in both FIG. 1 and FIG. 2, a bead seat 30 is peripherally formed on the wheel rim 28. The tire bead 16 rests in the beat seat 30.

Formed at the heart of the tire bead 16 is a tire bead core 32. The internal breaker 24 defines a pocket 34 which envelopes the tire bead core 32 and a bead filler 36. The tire bead core 32 conventionally comprises a bundle of individual wires 38.

The disclosed inventive concept is provided to overcome the known NVH challenges faced by today's tire design. With reference to FIG. 3, a detailed cross sectional view of the bead portion wherein the wires are encased in a sheath according to the disclosed inventive concept is illustrated.

Referring to FIG. 3, a cross-sectional view of a ring-like bead portion of a pneumatic tire according to the disclosed inventive concept is illustrated. The bead portion is generally illustrated as 40. The bead portion 40 is formed as part of a pneumatic tire 42 that includes a sidewall 44. An inner liner 46 is formed on the inside of the pneumatic tire 42. An internal breaker 48 is continuously formed within the pneumatic tire 42 between the peripheral crown (not shown) and the bead portion 40. Between the internal breaker 48 and the inner liner 46 is formed a tire carcass 50

The pneumatic tire 42 is conventionally mounted on a wheel rim 52. As illustrated in both FIG. 3, a bead seat 54 is peripherally formed on the wheel rim 54. The tire bead portion 40 rests in the beat seat 54.

Formed at the approximate center of the tire bead portion 40 is a tire bead core 56. The internal breaker 48 defines a pocket 58 which envelopes the tire bead core 56 and a bead filler 60. The tire bead core 56 conventionally comprises a bundle of individual wires 62 that are surrounded, wrapped or otherwise encased by a sheath 64 that is impermeable to the in-flow of rubber material. The individual wires 62 are preferably though not exclusively steel monofilament wire. The individual wires 62 may be of the same diameter (as illustrated FIG. 3 and discussed in conjunction therewith) or may be of different diameters (as illustrated FIG. 4 and discussed in conjunction therewith). The bundle of individual wires 62 and the surrounding impermeable sheath 64 define a vibration-damping rope 66. The bundle of individual wires 62 may be provided within the impermeable sheath 64 either in a linear arrangement or in a twisted or helical arrangement. A greater or lesser number of wires may form the bundle of individual wires 62 than are illustrated. By adjusting the number, diameter, and internal configuration of the individual wires that comprise the bundle of individual wires 62, the vibration-damping rope 66 according to the disclosed inventive concept may be virtually infinitely tuned to thereby adjust the friction or damping frequencies of the pneumatic tire 42.

Each wire of the bundle of individual wires 62 is preferably made of steel although other metals may be selected for this use. The individual wires within a single vibration-damping rope 66 may be made of the same metal or of different metals. The impermeable sheathing is preferably although not absolutely formed from any one of several elastomeric materials such as the same rubber as that of the pneumatic tire 42 or may be formed from natural or synthetic rubber or rubber-like materials, though the vibration-damping rope 66 is preferably formed as a separate component prior to being molded into the pneumatic tire 42 as discussed below. While a single vibration-damping rope 66 is illustrated as being positioned within the pneumatic tire 42, it is to be understood that more than one vibration-damping rope 66 may be so positioned.

A feature of the disclosed inventive concept is the interface between some of the individual wires of the bundle of individual wires and the impermeable sheath that is illustrated in FIG. 4 in which a detailed cross-section of a first embodiment of the vibration-damping rope is illustrated. With reference thereto, a vibration-damping rope 80 is illustrated. The vibration-damping rope 80 includes an impermeable sheath 82 having an inner surface 84. A bundle of individual wires 86 is provided within the impermeable sheath 82 and includes an outermost array of wires 88 and inner wires 90. According to the embodiment of the vibration-damping rope illustrated in FIG. 4, the wires making up the bundle of individual wires 86 are of the same diameter. As illustrated, each wire or most of the wires that make up the outermost array of wires 88 is at least partially embedded within the inner surface 84 of the impermeable sheath 82. By embedding only the outermost array of wires 88 in the inner surface 84 of the impermeable sheath 82, a coulomb friction results between the central, non-bedded wires of the bundle of individual wires 86 that are positioned within the outermost array of wires 88. This friction provides a significant increase in the damping capacity of the bead portion 40 which reduces the noise emission of the pneumatic tire 42.

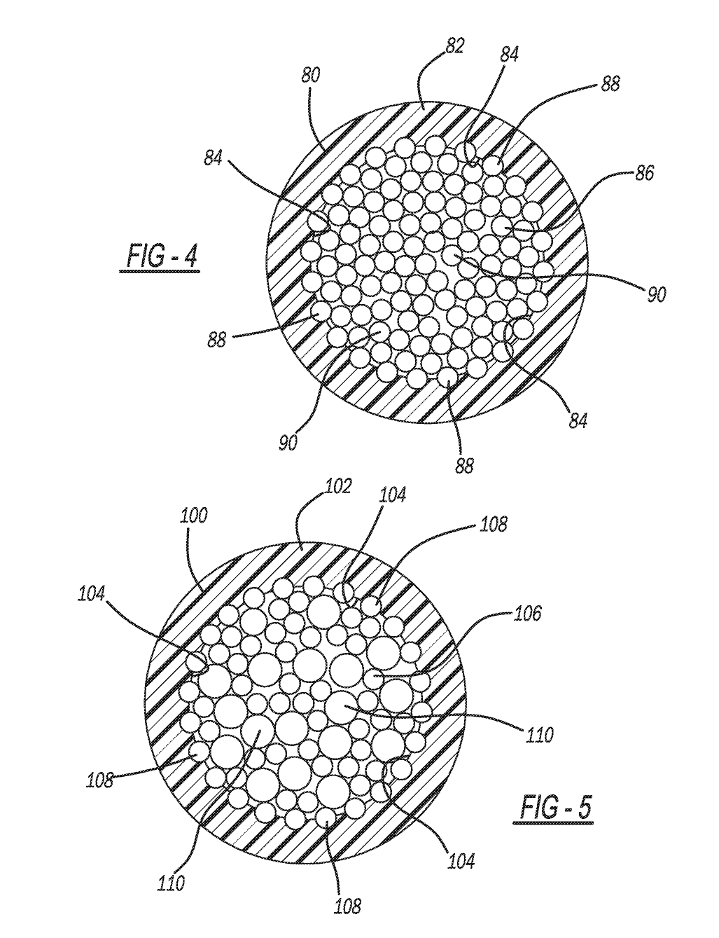

A variation of the disclosed inventive concept is illustrated in FIG. 5 which shows a detailed cross-section of a second embodiment of the vibration-damping rope is illustrated. With reference thereto, a vibration-damping rope 100 is illustrated. The vibration-damping rope 100 includes an impermeable sheath 102 having an inner surface 104. A bundle of individual wires 106 is provided within the impermeable sheath 102 and includes an outermost array of wires 108 and inner wires 110. According to the embodiment of the vibration-damping rope illustrated in FIG. 5, the wires making up the bundle of individual wires 106 are of different diameters. By providing wires having different diameters as illustrated in the embodiment of the disclosed concept illustrated in FIG. 5, the Hertzian stress is altered and, with it, the contact area, thus resulting in changed friction and increased damping. As illustrated, each wire or most of the wires that make up the outermost array of wires 108 is at least partially embedded within the inner surface 104 of the impermeable sheath 102. By embedding only the outermost array of wires 108 in the inner surface 104 of the impermeable sheath 102, a coulomb friction results between the central, non-bedded wires of the bundle of individual wires 106 that are positioned within the outermost array of wires 108.

The vibration-damping rope 66, 80 is preferably though not absolutely formed by first forming the individual wires then bundling them to form the bundle of individual wires 62, 86. The formed bundle of individual wires 62, 86 is then run through an extruder together with material that will ultimately form the impermeable sheath 64, 82 in a process in which the temperature of the encasing rubber or rubber-like material is regulated to soften said inner surface 68, 84 so that the outermost array of wires 70, 88 become partially embedded within the inner surface 68, 84 of the impermeable sheath 64, 82 as discussed above. One formed vibration-damping rope 66, 80 is then positioned in each of the two tire openings of the tire mold (not shown). Other elements of the pneumatic tire 42, including the internal breaker 48, are placed in the mold as well. Thereafter the mold is filled with tire-forming rubber or rubber-like material to form the pneumatic tire 42. The molded tire having the vibration-damping rope 66, 80 of the disclosed inventive concept embedded therein is then allowed to cool before being released from the tire mold as is known in the art.

The vibration-damping rope 66, 80 of the disclosed inventive concept has virtually unlimited applications when molded into virtually any rubber or other polymerized component. Because of the many conceivable variations of length and diameter of the vibration-damping rope 66, 80, it may be adapted for a virtually unlimited number of uses without compromising its dampening effectiveness. Thus the vibration-damping rope 66 may find applications beyond the applications illustrated herein in FIGS. 3, 4 and 5.

One skilled in the art will readily recognize from such discussion, and from the accompanying drawings and claims that various changes, modifications and variations can be made therein without departing from the true spirit and fair scope of the invention as defined by the following claims.

What is claimed is:

1. A bead core for a pneumatic tire comprising:
a bundle of wires, said bundle including an outermost layer of wires; and
a polymerized sheath formed over said bundle of wires, said sheath having an inner layer, at least some of said outermost layer of wires being embedded in said inner layer of said sheath, whereby sliding movement of the surfaces of said wires relative to one another dampens resonant vibration of the pneumatic tire.

2. The bead core for a pneumatic tire of claim 1, wherein said wires are composed of a metal, said metal of all of said wires being the same.

3. The bead core for a pneumatic tire of claim 1, wherein some of said wires are composed of a first metal and some of said wires are composed of a second metal, said first and second metals being different.

4. The bead core for a pneumatic tire of claim 1, wherein said wires are of the same diameter.

5. The bead core for a pneumatic tire of claim 1, wherein said wires are of different diameters.

6. The bead core for a pneumatic tire of claim 1, wherein said sheath is composed of a polymerized material, said material being impermeable to the in-flow of the rubber material of the tire.

7. The bead core for a pneumatic tire of claim 1, wherein said bead core includes a first end and a second end, said first end and said second being joined to form a rope ring.

8. The bead core for a pneumatic tire of claim 1, wherein said wires are arranged linearly or helically.

9. A pneumatic radial tire comprising:
a sidewall having a bead portion; and
a bead core embedded in said portion, said core comprising a bundle of wires having an outermost layer, said core further having a polymerized sheath formed thereover, said sheath having an inner layer, at least some of said outermost layer being embedded in said inner layer, whereby sliding movement of the surfaces of said wires relative to one another dampens resonant tire vibration.

10. The pneumatic radial tire of claim 9, wherein each wire of said bundle of wires is composed of a metal, said metal of all of said wires being the same.

11. The pneumatic radial tire of claim 9, wherein some of said wires are composed of a first metal and some of said wires are composed of a second metal, said first and second metals being different.

12. The pneumatic radial tire of claim 9, wherein said wires are of the same diameter.

13. The pneumatic radial tire of claim 9, wherein said wires are of different diameters.

14. The pneumatic radial tire of claim 9, wherein said polymerized sheath envelopes said bundle of wires, and wherein said polymerized sheath is composed of an impermeable polymerized material that is impermeable to the in-flow of the rubber material of the tire.

15. The pneumatic radial tire of claim 9, wherein said bead core includes a first end and a second end, said first end and said second being joined to form a rope ring.

16. The pneumatic radial tire of claim 9, wherein said wires are arranged linearly or helically.

17. A method of forming a vibration-damping rope for use in a pneumatic tire, the method comprising:
forming an array of wires in a wire bundle, said wire bundle having an outermost array of wires;
placing at least a portion of said wire bundle into an extruder;
adding a polymerizable material to said extruder to form an outer layer over said wire bundle; and
extruding said wire bundle and said outer layer whereby at least a portion of said outermost array of wires is embedded in said impermeable layer.

18. The method of forming the vibration-damping rope of claim 17, wherein said outer layer is an impermeable layer.

19. The method of forming the vibration-damping rope of claim 17, whereby said step of embedding at least a portion of said outermost layer of wires in said polymerizable material includes regulating the temperature of said polymerizable material during the extrusion process.

20. The method of forming the vibration-damping rope of claim 17, wherein said wires are arranged linearly or helically.
